(19) United States
(12) Patent Application Publication
(10) Pub. No.: US 2024/0262005 A1
(43) Pub. Date: Aug. 8, 2024

(54) SYSTEM AND METHOD FOR MANUFACTURING A MATERIAL

(71) Applicant: UNIVERSITE DE BRETAGNE SUD, Lorient (FR)

(72) Inventor: Yohan JACQUET, Lorient (FR)

(73) Assignee: UNIVERSITE DE BRETAGNE SUD, Lorient (FR)

(21) Appl. No.: 18/564,795

(22) PCT Filed: Jun. 2, 2022
(86) PCT No.: PCT/FR2022/051039

§ 371 Date: Nov. 28, 2023

(30) Foreign Application Priority Data
Jun. 2, 2021 (FR) 2105830

(51) Int. Cl. B28B 23/02; B28B 1/00; B33Y 10/00; B33Y 30/00; B33Y 40/00

(52) U.S. Cl. CPC B28B 23/02; B28B 1/001; B33Y 10/00; B33Y 30/00; B33Y 40/00

(57) ABSTRACT

A system and a method for manufacturing a composite building material including a printed matrix and a continuous fiber embedded in this matrix, the system including a printhead configured to deposit the printed matrix by depositing material in successive layers on a deposition plane, and an injection device configured to inject the continuous fiber into the matrix deposited by the printhead, the injection device including a distribution head configured to deliver the fiber, and a drive device configured to swing the distribution head between a high position and a low position.

### FIELD

The present invention relates to a system and method for manufacturing a printed work.

More specifically, the invention relates to a system and a method for manufacturing a construction material comprising a printed matrix and a reinforcing fiber.

### BACKGROUND

We know 3D construction printers allowing the construction of buildings or parts of buildings via the deposition of material in successive layers on a deposition plan, from a three-dimensional model of the structure.

However, the work thus obtained has poor mechanical properties. Indeed, a progressive stiffening, or setting, of the layers is necessary in order to guarantee the dimensional stability of the structure. However, the faster drying at the interlayer, and delayed in the center of the layer, makes the bonds between the layers mechanically weak.

Solutions are known for reinforcing a printed construction material, consisting of placing reinforcing elements, such as for example steel bars, nails, or screws, at G inter-layer. Alternatively, the building material can be printed around a lattice. However, these solutions remain relatively limited because they are not compatible with all the shapes and/or compositions of the printed material. We also observe in these types of reinforcements local detachments due to the lack of adhesion between the reinforcing element and the printed material. In addition, they are complex, cannot be automated and expensive.

One solution to get around these problems is to add reinforcing fibers to the printed construction material. For example, pieces of fiber can be introduced directly into the building material before printing. This solution is, however, unsatisfactory when it comes to improving adhesion between layers and makes extrusion difficult.

An objective of the present invention is to provide a manufacturing system and method making it possible to resolve the drawbacks of the prior art, and to obtain construction materials with improved mechanical performance.

### SUMMARY

The invention therefore relates to a system for manufacturing a composite construction material comprising a printed matrix and a continuous fiber embedded in said matrix, the system comprising a print head configured to deposit the matrix by deposition of material in successive layers on a deposition plane, and an injection device configured to introduce the continuous fiber into the matrix deposited by the print head.

The injection device includes:
a distribution head configured to deliver the fiber, said distribution head being movable in a vertical direction perpendicular to the deposition plane, between a high position and a low position;
a drive device configured to oscillate the dispensing head between the high position and the low position; and
an elastic return element configured to passively return the dispensing head from the low position to the high position.

Advantageously, the system allows to introduce the fiber into the printed matrix during deposition and thus create a continuous pattern in said matrix. The construction material obtained does not require the successive introduction of reinforcing elements.

In the present invention, by “reinforcement” we mean the material produced and introduced, thanks to the injection device, into a printed matrix. By “printed matrix” we mean a material printed with a 3D printer. The printed matrix can be a composite material, for example concrete, or any other material with a colloidal matrix.

Specifically, moving the dispensing head along the vertical direction allows the fiber to be introduced in a pattern through multiple layers, thereby increasing adhesion between printed matrix layers.

Advantageously, the passive return of the dispensing head from the low position to the high position allows to simplify the operation of the training device. Indeed, in this exemplary embodiment the movement of the dispensing head from its low position to its high position can be ensured by the elastic return element, while the movement in the opposite direction (from the high position to the position low) can be ensured by the training device.

By reducing the torque supplied by the drive device, it is possible to use a drive device with more compact dimensions.

In one embodiment, the injection device includes a first feed device configured to deliver the fiber to the distribution head. A continuous tubular guide (PTFE tube for example) can advantageously be used.

The first power supply device may for example comprise a coil. Advantageously, a spool allows to store a very long and continuous fiber.

In one embodiment, the distribution head comprises a hollow needle capable of being traversed by the continuous fiber.

A hollow needle allows to deliver and guide a semi-rigid or flexible fiber as well as a fluid material.

In one embodiment, the distribution head is configured to deliver interphase material with the fiber.

This configuration allows to deliver an interphase material. The interphase material may be a material which impregnates the fiber, or a material which envelops the fiber, or which is deposited together with the fiber in the printed matrix. Advantageously, the interphase material forms an interface between the fiber and the printed matrix. It therefore allows, among other things, to improve the adhesion between the fiber and the printed matrix.

In one embodiment, the injection device includes a second feed device configured to deliver the interphase material to the distribution head.

As mentioned above, in one embodiment, the dispensing head includes a hollow needle.

Advantageously, the needle has a diameter of between 2 mm and 3 cm, and a length of between 50 mm and 200 mm. A needle of this size can easily be introduced into a printed matrix during deposition, and pass through at least one deposited layer. In addition, it allows to obtain, thanks to its hollow part, a sufficient flow of interphase material.

In one embodiment, the system includes a controllable flow pump to deliver the interphase material to the distribution head.

Advantageously, the pump allows to deliver a liquid interphase material.

In one embodiment, the drive device is configured to oscillate the dispensing head between the high position and the low position at a predetermined frequency and amplitude.

This configuration allows to periodically introduce, at the predetermined frequency, the dispensing head into the printed matrix. At each introduction, at least one inter-layer is crossed by the distribution head. The number of interlayers crossed depends on the amplitude of the oscillation.

The fiber delivered by the oscillating distribution head thus forms a periodic and continuous pattern in the printed matrix. The pattern has an amplitude determined by the amplitude of the oscillation, and a periodicity determined by the frequency of oscillation.

The invention also relates to a method of manufacturing a composite construction material comprising a printed matrix and a continuous fiber embedded in said matrix, the method comprising a step of depositing at least two layers of printed matrix, and a step of insertion of the continuous fiber inside the at least two layers.

Advantageously, the continuous fiber ensures multidirectional continuity of the reinforcement. In addition, the pattern of the continuous fiber passes back and forth through at least two inter-layers, which improves adhesion between the layers of printed matrix.

Overall, the process allows to obtain a composite material with improved mechanical strength, thanks to the better adhesion between the deposited layers and the multidirectional continuity of the reinforcement. In addition, the process is very fast because the reinforcing fiber is delivered into the printed matrix during printing. No successive step of introducing a reinforcing material is therefore required.

In one embodiment, the printed matrix includes concrete, foam concrete, insulating foam, clay material. These construction materials are compatible with additive manufacturing based on printing by extrusion/deposition of material in successive layers.

In one embodiment, the method further comprises, during the insertion step, the introduction of an interphase material with the continuous fiber through the at least two layers.

Advantageously, the interphase material allows to improve the adhesion between the fiber and the printed matrix.

In one embodiment, the printed matrix includes concrete, foam concrete, insulating foam, clay material.

For example, the interphase material can be a cementitious matrix, an earth-based matrix, a polymer matrix. These materials are characterized by high mechanical performance and high adhesion to the fiber.

In one embodiment, the fiber is a steel fiber, a carbon fiber, a plant fiber, or a synthetic fiber, preferably in the form of a braid, a wire, or a strand.

Advantageously, a fiber in the form of a porous braid (or strand) allows to improve adhesion with the matrix and/or the interphase material.

In one embodiment, the distance between the high position and the low position is adjustable between 5 cm and 50 cm in accordance with the dimensions of the printed structure.

In one embodiment, the speed of movement of the distribution head between the high position and the low position (frequency of the oscillation) is adjustable in order to vary the periodicity of the fiber pattern. By varying the periodicity of the fiber pattern, it is possible to vary the density of reinforcements.

Preferably, the periodicity of the fiber pattern is between 5 cm and 20 cm.

Preferably, the method uses a system as described above. In this case, the deposition step comprises the deposition of at least two layers of matrix printed by the print head, and the insertion step comprises the following successive phases:
an injection phase during which the distribution head is moved along the vertical position from its high position to its low position;
a return phase during which the dispensing head is moved along the vertical position from its low position to its high position;
a neutral phase during which the distribution head is in the high position.

The fiber is delivered via the distribution head during these three phases, which allows to obtain a continuous fiber embedded in the printed matrix.

In one embodiment, interphase material is introduced through printed matrix layers via the dispensing head at least during the injection phase.

The delivery of the interphase material can be prolonged with a lower flow rate in order to promote adhesion between layers. The use of this interphase material in this way can, if necessary, help to resolve the drying problems mentioned above.

### BRIEF DESCRIPTION OF THE DRAWINGS

FIG. 1 is a perspective view of a system 1 according to one embodiment of the invention.

FIG. 2 is a front view showing the system 1 of FIG. 1.

FIG. 3 is a perspective view showing an example of a pattern defined by the fiber within the printed matrix.

For purposes of illustration, the system 1 is shown in preferred embodiments. It should be understood, however, that the present application is not limited to the precise arrangements, structures, features, embodiments and appearances shown. The drawings are not drawn to scale and are not intended to limit the scope of the claims to the embodiments shown therein.

### DETAILED DESCRIPTION

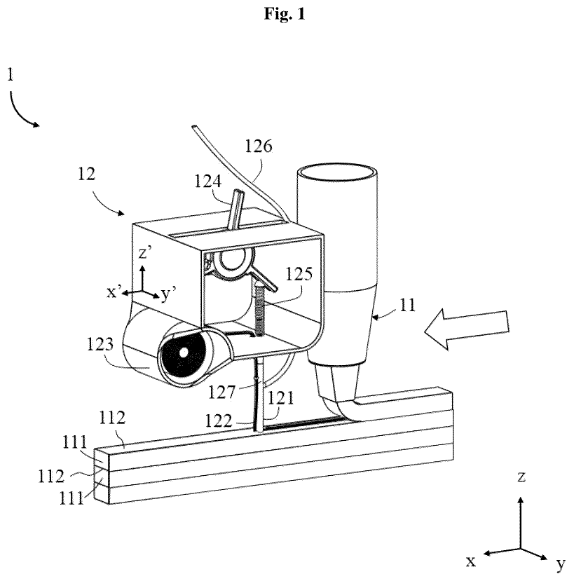

FIG. 1 shows a system 1 comprising a print head 11 for depositing material (the printed matrix) in successive layers 111, and an injection device 12 for delivering a fiber 122.

The injection device 12 comprises a fixed part, integral with the print head 11 and a distribution head 121.

By “dispensing head” we mean the mobile part of the injection device 12. The distribution head 121 is capable of receiving a product (a fiber, a fluid, etc.) stored in a supply device 123 such as a container, a reel, a reservoir, and conveying this product from its device feed 123 to the printed matrix.

For example, the dispensing head 121 may comprise one or more channels communicating, on the one hand, with the supply device 123 containing the product to be distributed and, on the other hand, with the outside. In this case, during its movement, the dispensing head 121 can take a position in which the end communicating with the outside is in contact with the printed matrix, thus allowing the introduction of the product within the matrix.

The system 1 thus allows to obtain a composite construction material comprising a printed matrix, that is to say the material deposited by the print head 11, and a fiber 122 embedded in this printed matrix.

The print head 11 moves on a horizontal xy plane (direction indicated by the white arrow), also called “deposition plane”. During its movement, the print head 11 deposits the printed matrix layers 111 on the xy deposition plane.

The injection device 12 is integral with the print head 11. Its movement on the xy deposition plane is therefore synchronized with that of the print head 11.

Consequently, if the print head 11 is capable of rotating around a vertical axis z, the injection device 12 can also follow this rotation.

The injection device 12 secured to the print head 11 allows to use a single command (for example a G-code) for the injection device 12 and for the print head 11.

For example, the injection device 12 can be attached to the print head 11 or fixed to the print head 11 via a clamp or any other reversible fixing mechanism. The reversible attachment on the print head 11 allows to provide a versatile injection device which can be adapted to any print head.

The injection device 12 comprises a distribution head 121 which is intended to deliver the fiber 122 within the matrix printed by the print head 11. For example, the fiber 122 can be guided along the distribution head 121 using a guide 127. A PTFE-based tube can advantageously be used to guide the fiber along the injection device. Alternatively, the distribution head 121 may present a light to guide the fiber.

Advantageously, the guide 127 can be made of a material which limits friction, for example Teflon. The guide 127 can for example be a ring or a tube.

Preferably, the guide 127 is a hollow needle. A needle has a shape that is particularly suited to piercing the printed matrix and crossing its layers.

The hollow needle allows for better versatility because it allows the fiber to be delivered along an exterior surface of the needle or inside the hollow part of the needle. In addition, a hollow needle also allows to inject a fluid material into the printed matrix.

The movement of the dispensing head 121 along the vertical direction z is ensured by a drive device 124, which causes the dispensing head 121 to oscillate between a low position and a high position.

The injection device 12 may also include an elastic return element 125. In this case, the drive device 124 can ensure the movement of the dispensing head 121 from the high position to the low position and the passive elastic return element 125 can return the dispensing head from the low position to the position high. The use of an elastic return element 125 is advantageous because it allows to increase the reactivity of the system 1. Indeed, increasing the reactivity of the system 1 allows to minimize the damage in the printed matrix due to the penetration of the injection device 12 advancing with the print head 11 (the higher the printing speed, the greater the oscillation of the injection device 12 must be brief, otherwise a significant part of the printed matrix would be damaged). The elastic return element 125 being passive, it allows instantaneous reactivity unlike the reactivity time of an active actuator (such as a motor). In fact, the return element 125 moves the dispensing head from the low position to the high position instantly as soon as the force applied to the elastic return element 125 is canceled. This elastic return element therefore allows to overcome the requirements in terms of reactivity of a possible motor and the associated cost: such a motor would rotate a rocker arm at a known speed and therefore a known period of time, and the return would take place when the head of the oscillating needle is not in contact with a rocker arm.

In the exemplary embodiment illustrated in FIG. 1, the passive elastic return element 125 is a helical spring wound around a high end of the dispensing head 121. This spring rests on the body of the injection device 12, which constrains it when moving the distribution head 121 from its high position towards its low position. Stretching the spring causes the dispensing head to translate in the opposite direction, that is to say from its low position, towards its high position.

Advantageously, the elastic return element 125 allows to simplify the operation of the drive device 124. For example, the drive device 124 may be a stepper motor or a servomotor. In this case, the movement of the distribution head from the low position to the high position is done with the motor freewheeling.

Alternatively, the drive device 124 may include a servomotor working in both directions, a linear actuator such as a linear motor, or a cylinder capable of giving a back-and-forth movement to the distribution head. In this case, the injection device 12 does not include an elastic return element 125.

As detailed in FIG. 1, the injection device 12 may include a feed device 123 configured to bring the fiber to the distribution head. In this example, the feed device 123 is a spool, which allows to store a very long and continuous fiber.

Advantageously, the distribution head 121 can be configured to deliver an interphase material 128 with the fiber 122.

For example, the injection device 12 may comprise a second supply device intended to contain the interphase material 128. The interphase material 128 can thus be conveyed from the second supply device to the distribution head 121 using a pump (for example a peristaltic pump) with a controllable flow rate and a pipe 126. The use of a controllable flow pump is advantageous because it allows to pump an interphase material 128 characterized by high mechanical performance. The high mechanical performance allows to increase the adhesion between the interphase material 128 and the printed matrix, thus allowing to increase the charge transfer between the two materials. In addition, controlling the quantity of interphase material 128 injected into the printed matrix allows to significantly increase the adhesion between the layers of the printed matrix and thus reduce the areas of mechanical weakness between these layers. Ultimately, flow control by the pump allows to compensate for the damage to the matrix induced by oscillation of the injection device 12 at the heart of the matrix by an injection of material with superior mechanical performance.

In this case, an actuator can activate the pump when the distribution head 121 is in its low position, and stop the pump when the distribution head 121 is in its high position. This configuration allows to deliver the interphase material 128 when the distribution head 121 is within the printed matrix. The actuator can activate the pump as soon as the dispensing head 121 reaches the printed matrix during its movement from its high position to its low position, which allows to obtain a sufficient volume of interphase material 128 even in the event of low flow.

The dispensing head 121 may include an inlet orifice, an outlet orifice and a cavity into which said orifices open. In this case, the interphase material 128 can be introduced into the cavity of the distribution head 121 using a pipe 126. This configuration allows to deliver a fluid interphase material 128. The interphase material 128 thus passes through the cavity of the distribution head 121 to the outlet orifice. Near the outlet, the fiber 122 comes into contact with the interphase material 128, which envelops it (for example if the interphase material 128 is very viscous) and/or impregnates it at least partially (liquid interphase material 128).

In an alternative embodiment (not illustrated), the fiber 122 is also introduced into an orifice of the distribution head. For example, it can be introduced into the same orifice which receives the interphase material 128, or into a separate orifice.

Advantageously, the interphase material 128 forms an interface between the fiber 122 and the printed matrix which allows to improve fiber/matrix adhesion.

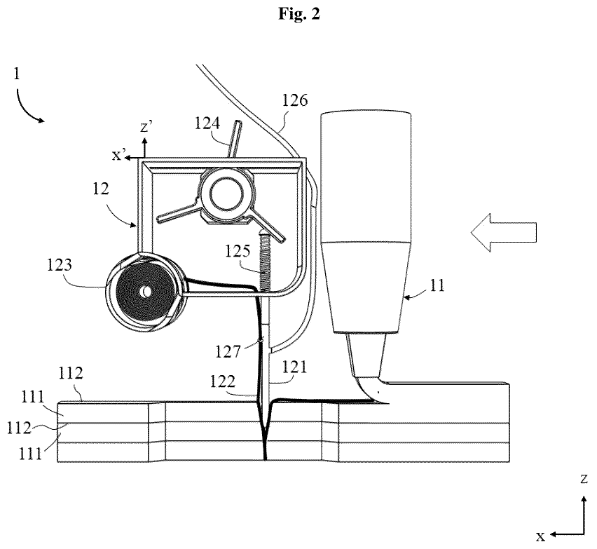

FIG. 2 shows a front view of the system of FIG. 1, in which part of the printed matrix is hidden, for a better understanding of the movement of the distribution head 121, and the introduction of the fiber 122 within the printed matrix.

The trajectory of the dispensing head 121 is the result of two movements: the oscillation of the dispensing head 121 along the vertical direction z (between the high position and the low position), and its movement on the deposit plane xy.

When the dispensing head 121 is in its high position, it does not come into contact with the printed matrix.

When the dispensing head 121 is in its low position, it is located within the printed matrix (FIG. 2).

The fiber 122 is delivered via the movable distribution head 121, it therefore forms a continuous pattern in the printed matrix which follows the trajectory of the distribution head 121. This continuous pattern ensures the multidirectional continuity of the reinforcement within the printed matrix.

Furthermore, during its oscillation along the vertical direction z, the dispensing head 121 crosses, by making several round trips, at least one interlayer 112, that is to say at least two layers 111.

Consequently, the continuous pattern formed by the fiber 122 connects the layers 111 together, thus allowing to improve adhesion between successive layers 111.

It should be noted that existing solutions for reinforcing printed construction materials do not allow satisfactory results to be obtained because they do not in any way affect the adhesion between layers 111.

Poor adhesion between the deposited layers 111 generates heterogeneity in the mechanical performance of the printed material in the z direction perpendicular to the xy deposition plane.

In addition, poor adhesion between layers 111 tends to reduce the performance of the material in bending.

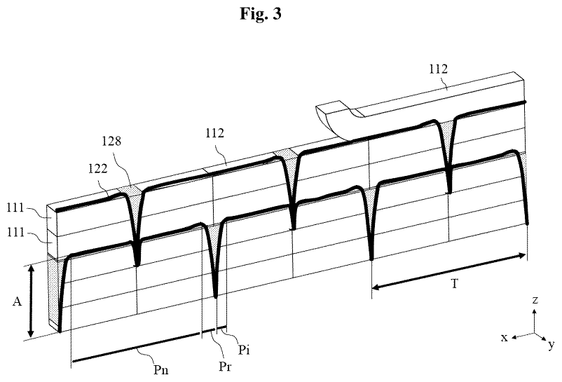

FIG. 3 illustrates an example of a continuous pattern formed by the fiber 122 within the printed matrix. In this example, the fiber 122 passes through three layers 111 of this matrix.

The continuous pattern of the fiber 122 is characterized by an amplitude A and a periodicity T.

Advantageously, it is possible to vary the amplitude A and the periodicity T of the pattern, by varying the amplitude and frequency of the oscillation imposed by the drive device 124, respectively.

By varying the amplitude A of the pattern, it is possible to modify the number of layers 111 crossed by the fiber 122.

Preferably, the amplitude A of the pattern is between 5 cm and 50 cm.

By varying the frequency of the oscillation, it is possible to modify the periodicity T of the pattern. For example, the drive device 124 may include a motor and a controller configured to control the rotational speed of the motor. Alternatively, the drive device 124 may comprise a linear actuator such as a linear motor, or a cylinder capable of giving a back-and-forth movement to the distribution head.

Preferably, the periodicity T of the pattern is between 5 cm and 20 cm.

The system 1 according to the invention is particularly suitable for the manufacture of a construction material. Indeed, these materials generally have the disadvantage of low tensile strength.

The printed matrix can be any printable building material (insulating or structural). It can be a composite material, or a homogeneous material.

For example, the printed matrix may be a polymer-based matrix.

Alternatively, the printed matrix can be a cementitious matrix, such as for example mortar, concrete, foam concrete.

Advantageously, the cement contained in these printable cement matrices can be replaced totally or in part with an earth-based material (clay, sediments), waste from the areas of recycling (and co-products from industry) or waste from construction. The manufacture of cement being a significant source of CO2 emissions, its replacement with these alternative binders allows to obtain a less polluting manufacturing process, and to recover industrial waste.

The fiber 122 can be a synthetic fiber, for example based on metals (preferably steel), nylon, carbon, glass, aramids, polyethylene (preferably very high molar mass polyethylene).

These fibers 122 have good mechanical properties and are flexible.

Alternatively, fiber 122 can be a plant fiber, based on hemp, linen, cotton, algae. Preferably, the fiber 122 is in the form of a braid, a wire, or a strand.

Advantageously, the fiber 122 in the form of a braid, or a strand is porous, which allows to promote adhesion between the fiber 122 and the printed matrix and/or the interphase material 128. In addition, braiding or twisting fiber 122 allows to improve its mechanical strength.

The interphase material 128 may be a cement slurry, an earth-based matrix (for example sediments and/or clay), a polymer matrix. These materials are characterized by high mechanical performance and high adhesion to the 122 fiber and the printed matrix.

The invention also relates to a method of manufacturing a composite construction material comprising a printed matrix and a continuous fiber 122 embedded in this printed matrix.

More precisely, the method comprises a step of depositing at least two layers 111 of printed matrix on a deposition plane xy, and a step of inserting the continuous fiber 122 inside the at least two layers 111.

Advantageously, the method can also include the introduction of an interphase material 128. In this case, the interphase material 128 is introduced with the continuous fiber 122 through the at least two layers 111, during the insertion step.

Preferably, the method uses a system 1 comprising a print head 11 and an injection device 12 as described above. In this case, the operating mode of the system 1 according to the preferred mode is as follows.

During a deposition step, at least two matrix layers 111 are printed by the print head 11 on the deposition plane xy.

This deposition step includes an injection phase (Pi), a return phase (Pr), and a neutral phase (Pn).

During the injection phase Pi the distribution head 121 is moved along the vertical position z from its high position to its low position (FIG. 2). This movement is ensured by the drive device 124.

This injection phase Pi allows to introduce fiber 122 into the printed matrix.

During the return phase Pr, the dispensing head 121 is moved along the vertical position z from its low position to its high position. Preferably, this return phase Pr is ensured by an elastic return element.

During the neutral phase Pn the distribution head 121 is in the high position. During this phase Pn there is no relative movement between the distribution head 121 and the injection device 12. Consequently, this neutral phase Pn corresponds to a horizontal line in the pattern defined by fiber 122 (FIG. 3).

It should be noted that in the example detailed in FIG. 3, an interphase material 128 is delivered during the injection phase Pi and the return phase Pr. However, the interphase material 128 can also be delivered during these neutral phase Pn, thus allowing to advantageously resolve any drying problems.

More precisely, in this example, the print head 11 has printed five layers 111 of matrix in five successive deposition steps, and a sixth deposition step is in progress. The distribution head 121 delivered the fiber 122 during the fourth deposition step (that is to say after deposition of the third layer 111 of printed matrix and during the deposition of the fourth layer 111) and during the sixth step of deposition (after deposition of the fifth layer 111 and during deposition of the sixth layer 111).

To make the figure easier to understand, the injection phases Pi, return Pr and neutral Pn are indicated relative to the fourth deposition step.

1-9. (canceled)

10. System for manufacturing a composite construction material comprising a printed matrix and a continuous fiber embedded in said matrix, the system comprising a print head configured to deposit the matrix by deposition of material in successive layers on a deposition plane, and an injection device configured to introduce the continuous fiber into the matrix deposited by the print head, the injection device comprising:
a distribution head configured to deliver the fiber, said distribution head being movable in a vertical direction perpendicular to the deposition plane, between a high position and a low position;
a drive device configured to oscillate the dispensing head between the high position and the low position; and
an elastic return element configured to passively return the dispensing head from the low position to the high position.

11. The system according to claim 10, in which the distribution head comprises a hollow needle capable of being traversed by the continuous fiber.

12. The system according to claim 11, wherein the distribution head is configured to deliver an interphase material with the fiber.

13. The system according to claim 10, wherein the distribution head is configured to deliver an interphase material with the fiber.

14. The system according to claim 10, comprising a pump with controllable flow for delivering the interphase material to the distribution head.

15. The system according to claim 10, wherein the drive device is configured to oscillate the dispensing head between the high position and the low position at a predetermined frequency and a predetermined amplitude.

16. A method of manufacturing a composite construction material comprising a printed matrix and a continuous fiber embedded in said matrix, the method comprising a step of depositing at least two layers of printed matrix, and a step of inserting the continuous fiber inside the at least two layers, said steps being carried out using the system for manufacturing a composite construction material according to claim 10.

17. The method according to claim 16, further comprising during the insertion step, introducing an interphase material with the continuous fiber through the at least two layers.

18. The method according to claim 17, wherein the printed matrix comprises concrete, concrete foam, insulating foam, a clay material.

19. The method according to claim 16, wherein the printed matrix comprises concrete, concrete foam, insulating foam, a clay material.

20. The method according to claim 16, in which the fiber is a steel fiber, a carbon fiber, a plant fiber, or a synthetic fiber.

21. The method according to claim 20, in which the fiber is in the form of a braid, a wire, or a strand.
